(19) United States
(12) Patent Application Publication
(10) Pub. No.: US 2007/0207400 A1
(43) Pub. Date: Sep. 6, 2007

(54) Toner composition and methods

(75) Inventors: Suresh K. Ahuja, Webster, NY (US); Zhen Lai, Webster, NY (US); Chieh-Min Cheng, Rochester, NY (US)

Correspondence Address: Carter, DeLuca, Farrell & Schmidt, LLP, Suite 225, 445 Broad Hollow Road, Melville, NY, 11741, US

(73) Assignee: Xerox Corporation

(21) Appl. No.: 11/368,830

(22) Filed: Mar. 6, 2006

(51) Int. Cl. G03G 9/087

(52) U.S. Cl. 430/109.4; 430/137.1; 430/111.4

(57) ABSTRACT

Toner compositions prepared with stable latex emulsions and method for characterizing stable latex emulsions are provided.

### BACKGROUND

The present disclosure relates generally to toners and methods for characterizing the stability of toners and the components thereof to control and predict the quality of toners.

Methods of preparing an emulsion aggregation (EA) type toner are known. Toners may be formed by aggregating a colorant with a latex polymer formed by batch or semi-continuous emulsion polymerization. For example, U.S. Pat. No. 5,853,943, the disclosure of which is hereby incorporated by reference in its entirety, is directed to a semi-continuous emulsion polymerization process for preparing a latex by first forming a seed polymer. In particular, the '943 patent describes a process including: (i) conducting a pre-reaction monomer emulsification which includes emulsification of the polymerization reagents of monomers, chain transfer agent, a disulfonate surfactant or surfactants, and optionally an initiator, wherein the emulsification is accomplished at a low temperature of, for example, from about 5° C. to about 40° C.; (ii) preparing a seed particle latex by aqueous emulsion polymerization of a mixture including (a) part of the monomer emulsion, from about 0.5 to about 50 percent by weight, or from about 3 to about 25 percent by weight, of the monomer emulsion prepared in (i), and (b) a free radical initiator, from about 0.5 to about 100 percent by weight, or from about 3 to about 100 percent by weight, of the total initiator used to prepare the latex polymer at a temperature of from about 35° C. to about 125° C., wherein the reaction of the free radical initiator and monomer produces the seed latex comprised of latex resin wherein the particles are stabilized by surfactants; (iii) heating and feed adding to the formed seed particles the remaining monomer emulsion, from about 50 to about 99.5 percent by weight, or from about 75 to about 97 percent by weight, of the monomer emulsion prepared in (ii), and optionally a free radical initiator, from about 0 to about 99.5 percent by weight, or from about 0 to about 97 percent by weight, of the total initiator used to prepare the latex polymer at a temperature from about 35° C. to about 125° C.; and (iv) retaining the above contents in the reactor at a temperature of from about 35° C. to about 125° C. for an effective time period to form the latex polymer, for example from about 0.5 to about 8 hours, or from about 1.5 to about 6 hours, followed by cooling. Other examples of emulsion/aggregation/coalescing processes for the preparation of toners are illustrated in U.S. Pat. Nos. 5,290,654, 5,278,020, 5,308,734, 5,370,963, 5,344,738, 5,403,693, 5,418,108, 5,364,729, and 5,346,797, the disclosures of each of which are hereby incorporated by reference in their entirety. Other processes are disclosed in U.S. Pat. Nos. 5,348,832, 5,405,728, 5,366,841, 5,496,676, 5,527,658, 5,585,215, 5,650,255, 5,650,256 and 5,501,935, the disclosures of each of which are hereby incorporated by reference in their entirety.

The stability and quality of the emulsion aggregation toner is impacted by the quality of the latex monomers used. Latex emulsions may become unstable with time. Hence, time, temperature, or shear forces applied on the latex emulsions may cause the emulsion to phase separate. Unfortunately, visual inspection of latex emulsions does not necessarily indicate the stability or instability of the emulsion. Further, this qualitative approach is time consuming and not reliable. If the latex emulsion is unstable, the resulting latexes produce a toner with larger particle size, broader particle size distribution with relatively higher latex sedimentation, and broader molecular weight distribution. Toners with these properties have low image quality, such as poor image fix and low gloss, which is unacceptable to consumers.

In view of the recent demand for high image quality, toner prepared with a stable latex emulsion is desired. Hence, it would be advantageous to provide a toner composition with a stable latex emulsion and a method for characterizing the stability of the latex emulsion.

### SUMMARY

The present disclosure provides a method which includes obtaining a latex emulsion; shearing the latex emulsion at a rate of from about 100 sec⁻¹ to about 1 sec⁻¹; and measuring the viscosity of the latex emulsion, wherein the viscosity of the latex emulsion can be utilized to indicate stability of the latex emulsion.

Further provided in the present disclosure is a method which includes obtaining a latex emulsion; shearing the latex emulsion at a rate of from about 100 sec⁻¹ to about 1 sec⁻¹ for three consecutive cycles; and measuring the viscosity of the latex emulsion during shear deformation, wherein the viscosity of the latex emulsion can be utilized to indicate stability of a toner comprising the latex emulsion.

A toner composition is also provided in the present disclosure. The toner composition includes a latex wherein the latex includes a beta-carboxy ethyl acrylate monomer having a viscosity of from about 60 centipoise to about 90 centipoise.

### BRIEF DESCRIPTION OF THE DRAWINGS

Various embodiments of the present disclosure will be described herein below with reference to the figures wherein:

FIG. 1 is a graph showing viscosity as a function of shear rate for different β-CEA monomers.

FIG. 2 is a graph showing the repeatability of the β-CEA viscosity measurement.

FIG. 3 is a graph showing viscosity as a function of shear rate for latex emulsions prepared with stable and unstable β-CEA monomers.

FIG. 4 is a graph showing viscosity as a function of shear rate for latex emulsions prepared with stable and unstable β-CEA monomers.

### DETAILED DESCRIPTION

In accordance with the present disclosure, a method for characterizing the stability of latex emulsions is provided. Further provided are toner compositions which include a latex having a monomer with a specific viscosity.

Toners of the present disclosure may be an emulsion aggregation type toner prepared by the aggregation and fusion of latex resin particles and waxes with a colorant, and optionally one or more additives such as surfactants, coagulants, surface additives, and mixtures thereof. In embodiments, one or more may be from about one to about twenty, and in embodiments from about three to about ten. Any suitable latex used to produce emulsion aggregation toners may be utilized in the preparation of the toner.

In embodiments, the preparation of the toner includes forming a latex emulsion. The latex emulsion may be obtained by suspending monomer droplets in an aqueous phase containing a surfactant. Typically, the monomer is mixed with a surfactant aqueous solution until an emulsion is formed. In embodiments of the present disclosure, the viscosity of the latex emulsion may be used to characterize the stability and quality of the emulsion, and the resulting latex and toner formed. In embodiments, the viscosity of the latex emulsion is measured after shearing the emulsion. Shearing deformation may be accomplished by homogenizing at a shear rate of from about 100 sec⁻¹ to about 1 sec⁻¹, and in embodiments, of from about 100 sec⁻¹ to about 10 sec⁻¹. Typically, the shearing occurs for one cycle for a time period of from about 3 minutes to about 10 minutes and in embodiments, of from about 5 minutes to about 7 minutes. The shearing occurs for about one cycle to about four cycles and in embodiments, of from about one cycle to about three cycles. In embodiments, the viscosity may be measured after about three shearing cycles. Stable emulsions, higher quality latex and higher quality toner are produced with latex emulsions having a viscosity of from about 10 centipoise (CPS) to about 90 centipoise, and in embodiments of from about 15 centipoise to about 80 centipoise. In embodiments, the emulsion stability refers to the time elapsed prior to noticeable degradation of the emulsion as indicated by the formation of droplets much larger than in the original emulsion, typically noted by the macroscopic separation of the oil phase. In embodiments, the time for oil phase separation of a stable emulsion is above about 2 to about 4 hours; for unstable emulsion the time is less than about one hour.

In embodiments, the latex includes beta-carboxy ethyl acrylate (β-CEA), monomers, styrenes, butadienes, isoprenes, acrylates, methacrylates, acrylonitriles, acrylic acid, methacrylic acid, itaconic acid, and the like. In embodiments, β-Carboxyethyl acrylate (β-CEA), also called acryloxypropionic acid, is used. This resin plays a role in emulsion polymerization through affecting emulsion stability, particle nucleation, stabilization of the existing particles, and therefore impacting the resulting latex properties, such as particle size and size distributions, molecular weight and weight distributions, and the amount of sedimentations. Also, β-CEA provides improved adhesion and stability in emulsion polymers due to its —COOH groups being more available than those in the conventional carboxylic acids. Owing to its extended chain, β-CEA and the like is more compatible with other monomers, thus reducing aqueous phase polymerization and producing more uniform copolymers. β-CEA also enhances latex stability and improves rheology in high shear (i.e. a shear rate of over about 50 sec⁻¹).

Due to the nature of β-CEA synthesis (i.e. the oligomerization of acrylic acid through the Michael addition reaction), the industrial product of β-CEA usually consists of a mixture of acrylic acid oligomers, with the following chemical structure: 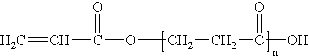
When n=0, it represents acrylic acid; when n=1, it represents β-CEA. In a typical β-CEA mixture, when n=6 the content of the acrylic acid oligomer is below 1 wt %. The quality of β-CEA is normally determined by the percentage of β-CEA (n=1), the acid value, ester value, and the amount of the inhibitor (MEHQ), and moisture level.

The viscosity of the beta-carboxy ethyl acrylate monomers used in the latex formulation affects the emulsion stabilities, polymer particle nucleation, and particle stabilization during the formation of the toner. Hence, the quality of the toner that may be formed can also be predetermined by the viscosity of the beta-carboxy ethyl acrylate monomers used during the emulsion polymerization of the latex. Stable emulsions prepared with beta-carboxy ethyl acrylate (β-CEA) monomers have a viscosity of from about 60 centipoise to about 90 centipoise, and in embodiments of from about 65 centipoise to about 80 centipoise.

In embodiments, the latex may use submicron resin particles which include, for example, particles having a size of, for example, from about 50 to about 500 nanometers, in embodiments from about 100 to about 400 nanometers in volume average diameter as determined, for example, by a Brookhaven nanosize particle analyzer. In embodiments, the submicron resin particles for the latex may be non-crosslinked. The resin may be present in the toner composition in an amount from about 75 weight percent to about 98 weight percent, and in embodiments from about 80 weight percent to about 95 weight percent of the toner or the solids of the toner. The expression solids can refer, in embodiments, for example to the latex, colorant, wax, and any other optional additives of the toner composition.

In embodiments, the resin of the latex may include at least one polymer. In embodiments, at least one may be from about one to about twenty and, in embodiments, from about three to about ten. Exemplary polymers includes styrene acrylates, styrene butadienes, styrene methacrylates, and more specifically, poly(styrene-alkyl acrylate), poly(styrene-1,3-diene), poly(styrene-alkyl methacrylate), poly (styrene-alkyl acrylate-acrylic acid), poly(styrene-1,3-diene-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(styrene-1,3-diene-acrylonitrile-acrylic acid), poly(alkyl acrylate-acrylonitrile-acrylic acid), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl acrylate-acrylic acid), poly(styrene-butyl methacrylate-acrylic acid), poly(butyl methacrylate-butyl acrylate), poly(butyl methacrylate-acrylic acid), poly(acrylonitrile-butyl acrylate-acrylic acid), and combinations thereof. In embodiments, the polymer is poly(styrene/butyl acrylate/beta carboxyl ethyl acrylate). The polymer may be block, random, or alternating copolymers.

In embodiments, the latex may be prepared by a batch or a semicontinuous polymerization resulting in submicron resin particles suspended in an aqueous phase containing a surfactant. Surfactants which may be used in the latex dispersion can be ionic or nonionic surfactants in an amount of from about 0.01 to about 15 weight percent of the solids, and in embodiments of from about 0.01 to about 5 weight percent of the solids.

Anionic surfactants which may be utilized include sulfates and sulfonates such as sodium dodecylsulfate (SDS), sodium dodecyl benzene sulfonate, sodium dodecylnaphthalene sulfate, dialkyl benzenealkyl sulfates and sulfonates, abitic acid, and the NEOGEN brand of anionic surfactants. In embodiments a suitable anionic surfactant includes Dowfax 2A1 from Dow Chemical Co., NEOGEN RK available from Daiichi Kogyo Seiyaku Co. Ltd., or TAYCA POWER BN2060 from Tayca Corporation (Japan), which are branched sodium dodecyl benzene sulfonates.

Examples of cationic surfactants include ammoniums such as dialkyl benzene alkyl ammonium chloride, lauryl trimethyl ammonium chloride, alkylbenzyl methyl ammonium chloride, alkyl benzyl dimethyl ammonium bromide, benzalkonium chloride, C₁₂, C₁₅, C₁₇ trimethyl ammonium bromides, mixtures thereof, and the like. Other cationic surfactants include cetyl pyridinium bromide, halide salts of quaternized polyoxyethylalkylamines, dodecyl benzyl triethyl ammonium chloride, MIRAPOL and ALKAQUAT available from Alkaril Chemical Company, SANISOL (benzalkonium chloride), available from Kao Chemicals, and the like. In embodiments a suitable cationic surfactant includes SANISOL B-50 available from Kao Corp., which is primarily a benzyl dimethyl alkonium chloride.

Exemplary nonionic surfactants include alcohols, acids, celluloses and ethers, for example, polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. In embodiments a suitable nonionic surfactant is ANTAROX 897 available from Rhone-Poulenc Inc., which is primarily an alkyl phenol ethoxylate.

In embodiments, the resin may be prepared with initiators, such as water-soluble initiators and organic soluble initiators. Exemplary water-soluble initiators include ammonium and potassium persulfates which can be added in suitable amounts, such as from about 0.1 to about 8 weight percent, and in embodiments of from about 0.2 to about 5 weight percent of the monomer. Examples of organic soluble initiators include Vazo peroxides, such as VAZO 64™, 2-methyl 2-2′-azobis propanenitrile, VAZO 88™, and 2-2′-azobis isobutyramide dehydrate and mixtures thereof. Initiators can be added in suitable amounts, such as from about 0.1 to about 8 weight percent, and in embodiments of from about 0.2 to about 5 weight percent of the monomers.

Known chain transfer agents can also be used to control the molecular weight properties of the resin if prepared by emulsion polymerization. Examples of chain transfer agents include dodecane thiol, dodecylmercaptan, octane thiol, carbon tetrabromide, carbon tetrachloride and the like in various suitable amounts, such as from about 0.1 to about 20 percent, and in embodiments of from about 0.2 to about 10 percent by weight of the monomer.

Other processes for obtaining resin particles include those produced by a polymer microsuspension process as disclosed in U.S. Pat. No. 3,674,736, the disclosure of which is hereby incorporated by reference in its entirety, a polymer solution microsuspension process as disclosed in U.S. Pat. No. 5,290,654, the disclosure of which is hereby incorporated by reference in its entirety, and mechanical grinding processes, or other processes within the purview of those skilled in the art.

In embodiments, a gel latex may be added to the latex resin suspended in the surfactant. A gel latex may refer, in embodiments, to a crosslinked resin or polymer, or mixtures thereof. In embodiments, the gel latex may be a mixture of a crosslinked resin and a non-crosslinked resin. Non-crosslinked resin particles may be composed of any of the latex resins or polymers described above.

The gel latex may include, for example, submicron crosslinked resin particles having a size of, for example, from about 10 to about 400 nanometers, and in embodiments from about 20 to 200 nanometers in volume average diameter. The gel latex may be suspended in an aqueous phase of water containing a surfactant, wherein the surfactant is selected in an amount from about 0.5 to about 5 percent by weight of the solids, and in embodiments from about 0.7 to about 2 percent by weight of the solids.

The crosslinked resin may be a crosslinked polymer such as crosslinked styrene acrylates, styrene butadienes, and/or styrene methacrylates. In particular, exemplary crosslinked resins are crosslinked poly(styrene-alkyl acrylate), poly(styrene-butadiene), poly(styrene-isoprene), poly(styrene-alkyl methacrylate), poly(styrene-alkyl acrylate-acrylic acid), poly(styrene-butadiene-acrylic acid), poly(styrene-isoprene-acrylic acid), poly (styrenealkyl methacrylate-acrylic acid), poly(alkyl methacrylate-alkyl acrylate), poly (alkyl methacrylate-aryl acrylate), poly(aryl methacrylate-alkyl acrylate), poly(alkyl methacrylate-acrylic acid), poly(styrene-alkyl acrylate-acrylonitrile acrylic acid), crosslinked poly(alkyl acrylate-acrylonitrile-acrylic acid), and mixtures thereof.

A crosslinker, such as divinyl benzene or other divinyl aromatic or divinyl acrylate or methacrylate monomers may be used in the crosslinked resin. The crosslinker may be present in an amount of from about 0.01 percent by weight to about 25 percent by weight, and in embodiments of from about 0.5 to about 15 percent by weight of the crosslinked resin.

The crosslinked resin particles may be present in an amount of from about 0.1 to about 50 percent by weight, and in embodiments of from about 1 to about 20 percent by weight of the toner.

The latex and gel latex may be added to a colorant dispersion. The colorant dispersion may include, for example, submicron colorant particles having a size of, for example, from about 50 to about 500 nanometers, and in embodiments of from about 80 to about 400 nanometers in volume average diameter. The colorant particles may be suspended in an aqueous water phase containing an anionic surfactant, a nonionic surfactant, or mixtures thereof. In embodiments, the surfactant may be ionic and from about 1 to about 25 percent by weight, in embodiments from about 4 to about 15 percent by weight of the colorant.

Colorants include pigments, dyes, mixtures of pigments and dyes, mixtures of pigments, mixtures of dyes, and the like. The colorant may be, for example, carbon black, cyan, yellow, magenta, red, orange, brown, green, blue, violet or mixtures thereof.

In embodiments wherein the colorant is a pigment, the pigment may be, for example, carbon black, phthalocyanines, quinacridones or RHODAMINE B™ type, red, green, orange, brown, violet, yellow, fluorescent colorants and the like.

The colorant may be present in the toner of the disclosure in an amount of from about 1 to about 25 percent by weight of toner, in embodiments in an amount of from about 2 to about 15 percent by weight of the toner.

Exemplary colorants include carbon black like REGAL 330® magnetites; Mobay magnetites including MO8029™, MO8060™; Columbian magnetites; MAPICO BLACKS™ and surface treated magnetites; Pfizer magnetites including CB4799™, CB5300™, CB5600™, MCX6369™; Bayer magnetites including, BAYFERROX 8600™, 8610™; Northern Pigments magnetites including, NP-604™, NP-608™; Magnox magnetites including TMB-100™, or TMB-104™, HELIOGEN BLUE L6900™, D6840™, D7080™, D7020™, PYLAM OIL BLUETM, PYLAM OIL YELLOW™, PIGMENT BLUE 1™ available from Paul Uhlich and Company, Inc.; PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario; NOVAPERM YELLOW FGL™, HOSTAPERM PINK E™ from Hoechst; and CINQUASIA MAGENTA™ available from E.I. DuPont de Nemours and Company. Other colorants include 2,9-dimethyl-substituted quinacridone and anthraquinone dye identified in the Color Index as CI 60710, CI Dispersed Red 15, diazo dye identified in the Color Index as CI 26050, CI Solvent Red 19, copper tetra(octadecyl sulfonamido) phthalocyanine, x-copper phthalocyanine pigment listed in the Color Index as CI 74160, Cl Pigment Blue, Anthrathrene Blue identified in the Color Index as CI 69810, Special Blue X-2137, diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33, 2,5-dimethoxy-4-sulfonanilide phenylazo-4′-chloro-2,5-dimethoxy acetoacetanilide, Yellow 180 and Permanent Yellow FGL. Organic soluble dyes having a high purity for the purpose of color gamut which may be utilized include Neopen Yellow 075, Neopen Yellow 159, Neopen Orange 252, Neopen Red 336, Neopen Red 335, Neopen Red 366, Neopen Blue 808, Neopen Black X53, Neopen Black X55, wherein the dyes are selected in various suitable amounts, for example from about 0.5 to about 20 percent by weight, in embodiments, from about 5 to about 18 weight percent of the toner.

As stated earlier, toner compositions of the present disclosure may further include a wax. The wax assists in toner release from the fuser roll during the fusing process. In embodiments, the wax may be in dispersion form. Wax dispersions suitable for use in toners of the present disclosure include, for example, submicron wax particles having a size of from about 50 to about 500 nanometers, in embodiments of from about 100 to about 400 nanometers in volume average diameter. The wax particles may be suspended in an aqueous phase of water and an ionic surfactant, nonionic surfactant, or mixtures thereof. The ionic surfactant or nonionic surfactant may be present in an amount of from about 0.5 to about 10 percent by weight, and in embodiments of from about 1 to about 5 percent by weight of the wax.

The wax dispersion according to embodiments of the present disclosure may include any suitable wax such as a natural vegetable wax, natural animal wax, mineral wax and/or synthetic wax. Examples of natural vegetable waxes include, for example, carnauba wax, candelilla wax, Japan wax, and bayberry wax. Examples of natural animal waxes include, for example, beeswax, punic wax, lanolin, lac wax, shellac wax, and spermaceti wax. Mineral waxes include, for example, paraffin wax, microcrystalline wax, montan wax, ozokerite wax, ceresin wax, petrolatum wax, and petroleum wax. Synthetic waxes, which may be used include, for example, Fischer-Tropsch wax, acrylate wax, fatty acid amide wax, silicone wax, polytetrafluoroethylene wax, polyethylene wax, polypropylene wax, and mixtures thereof.

Examples of polypropylene and polyethylene waxes include those commercially available from Allied Chemical and Baker Petrolite, wax emulsions available from Michelman Inc. and the Daniels Products Company, EPOLENE N-15 commercially available from Eastman Chemical Products, Inc., Viscol 550-P, a low weight average molecular weight polypropylene available from Sanyo Kasel K. K., and similar materials. In embodiments, commercially available polyethylene waxes which may be utilized possess a molecular weight (Mw) of from about 1,000 to about 1,500, and in embodiments of from about 1,250 to about 1,400, while commercially available polypropylene waxes may have a molecular weight of from about 4,000 to about 5,000, and in embodiments of from about 4,250 to about 4,750.

In embodiments, the waxes may be functionalized. Examples of groups added to functionalize waxes include amines, amides, imides, esters, quaternary amines, and/or carboxylic acids. In embodiments, the functionalized waxes may be acrylic polymer emulsions, for example, JONCRYL 74, 89, 130, 537, and 538, all available from Johnson Diversey, Inc, or chlorinated polypropylenes and polyethylenes commercially available from Allied Chemical and Petrolite Corporation and Johnson Diversey, Inc.

The wax may be present in an amount of from about 1 to about 30 percent by weight, and in embodiments from about 2 to about 20 percent by weight of the toner.

The resultant blend of latex dispersion, gel latex dispersion, colorant dispersion, and wax dispersion may be stirred and heated to a temperature of from about 45° C. to about 65° C., in embodiments of from about 48° C. to about 63° C., resulting in toner aggregates of from about 4 microns to about 8 microns in volume average diameter, and in embodiments of from about 5 microns to about 7 microns in volume average diameter.

In embodiments, a coagulant may be added during or prior to aggregating the latex, the aqueous colorant dispersion, the wax dispersion and the gel latex. The coagulant may be added over a period of time from about 1 to about 5 minutes, in embodiments from about 1.25 to about 3 minutes.

Examples of coagulants include polyaluminum halides such as polyaluminum chloride (PAC), or the corresponding bromide, fluoride, or iodide, polyaluminum silicates such as polyaluminum sulfo silicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate and the like. One suitable coagulant is PAC, which is commercially available and can be prepared by the controlled hydrolysis of aluminum chloride with sodium hydroxide. Generally, PAC can be prepared by the addition of two moles of a base to one mole of aluminum chloride. The species is soluble and stable when dissolved and stored under acidic conditions if the pH is less than about 5. The species in solution is believed to be of the formula Al₁₃O₄(OH)₂₄(H₂O)₁₂ with about 7 positive electrical charges per unit.

In embodiments, suitable coagulants include a polymetal salt such as, for example, polyaluminum chloride (PAC), polyaluminum bromide, or polyaluminum sulfosilicate. The polymetal salt can be in a solution of nitric acid, or other diluted acid solutions such as sulfuric acid, hydrochloric acid, citric acid or acetic acid. The coagulant may be added in amounts from about 0.02 to about 0.3 percent by weight of the toner, and in embodiments from about 0.05 to about 0.2 percent by weight of the toner.

Optionally a second latex can be added to the aggregated particles. The second latex may include, for example, submicron resin particles. The second latex may be added in an amount of from about 10 to about 40 percent by weight of the initial latex, and in embodiments in an amount of from about 15 to about 30 percent by weight of the initial latex, to form a shell or coating on the toner aggregates wherein the thickness of the shell is from about 200 to about 800 nanometers, and in embodiments from about 250 to about 750 nanometers.

In embodiments of the present disclosure, the latex and the second latex may be the same resin.

In embodiments, the latex and the second latex may be different resins.

Once the desired final size of the particles is achieved with a volume average diameter of from about 4 microns to about 9 microns, in embodiments of from about 5.6 microns to about 9 microns, and in embodiments of from about 5.6 microns to about 8 microns, the pH of the mixture may be adjusted with a base to a value of from about 4 to about 7, and in embodiments from about 6 to about 6.8. Any suitable base may be used such as, for example, alkali metal hydroxides including sodium hydroxide, potassium hydroxide, and ammonium hydroxide. The alkali metal hydroxide may be added in amounts from about 6 to about 25 percent by weight of the mixture, in embodiments from about 10 to about 20 percent by weight of the mixture.

The mixture is subsequently coalesced. Coalescing may include stirring and heating at a temperature of from about 90° C. to about 99° C., for a period of from about 0.5 to about 6 hours, and in embodiments from about 2 to about 5 hours. Coalescing may be accelerated by additional stirring.

The pH of the mixture is then lowered to from about 3.5 to about 6 and, in embodiments, to from about 3.7 to about 5.5 with, for example, an acid to coalesce the toner aggregates. Suitable acids include, for example, nitric acid, sulfuric acid, hydrochloric acid, citric acid and/or acetic acid. The amount of acid added may be from about 4 to about 30 percent by weight of the mixture, and in embodiments from about 5 to about 15 percent by weight of the mixture.

The mixture is cooled, washed and dried. Cooling may be at a temperature of from about 20° C. to about 40° C., in embodiments from about 22° C. to about 30° C. over a period time from about 1 hour to about 8 hours, and in embodiments from about 1.5 hours to about 5 hours.

In embodiments, cooling a coalesced toner slurry includes quenching by adding a cooling media such as, for example, ice, dry ice and the like, to effect rapid cooling to a temperature of from about 20° C. to about 40° C., and in embodiments of from about 22° C. to about 30° C. Quenching may be feasible for small quantities of toner, such as, for example, less than about 2 liters, in embodiments from about 0.1 liters to about 1.5 liters. For larger scale processes, such as for example greater than about 10 liters in size, rapid cooling of the toner mixture may not be feasible or practical, neither by the introduction of a cooling medium into the toner mixture, nor by the use of jacketed reactor cooling.

The washing may be carried out at a pH of from about 7 to about 12, and in embodiments at a pH of from about 9 to about 11. The washing may be at a temperature of from about 45° C. to about 70° C., and in embodiments from about 50° C. to about 67° C. The washing may include filtering and reslurrying a filter cake including toner particles in deionized water. The filter cake may be washed one or more times by deionized water, or washed by a single deionized water wash at a pH of about 4 wherein the pH of the slurry may be adjusted with an acid, optionally followed by one or more deionized water washes.

Drying may be carried out at a temperature of from about 35° C. to about 75° C., and in embodiments of from about 45° C. to about 60° C. The drying may be continued until the moisture level of the particles is below a set target of about 1% by weight, in embodiments of less than about 0.7% by weight.

The toner may also include any known charge additives in amounts of from about 0.1 to about 10 weight percent, and in embodiments of from about 0.5 to about 7 weight percent of the toner. Examples of such charge additives include alkyl pyridinium halides, bisulfates, the charge control additives of U.S. Pat. Nos. 3,944,493, 4,007,293, 4,079,014, 4,394,430 and 4,560,635, the disclosures of each of which are hereby incorporated by reference in their entirety, negative charge enhancing additives like aluminum complexes, and the like.

Surface additives can be added to the toner compositions of the present disclosure after washing or drying. Examples of such surface additives include, for example, metal salts, metal salts of fatty acids, colloidal silicas, metal oxides, strontium titanates, mixtures thereof, and the like. Surface additives may be present in an amount of from about 0.1 to about 10 weight percent, and in embodiments of from about 0.5 to about 7 weight percent of the toner. Examples of such additives include those disclosed in U.S. Pat. Nos. 3,590,000, 3,720,617, 3,655,374 and 3,983,045, the disclosures of each of which are hereby incorporated by reference in their entirety. Other additives include zinc stearate and AEROSIL R972® available from Degussa. The coated silicas of U.S. Pat. Nos. 6,190,815 and 6,004,714, the disclosures of each of which are hereby incorporated by reference in their entirety, can also be present in an amount of from about 0.05 to about 5 percent, and in embodiments of from about 0.1 to about 2 percent of the toner, which additives can be added during the aggregation or blended into the formed toner product.

Toner in accordance with the present disclosure can be used in a variety of imaging devices including printers, copy machines, and the like. The toners generated in accordance with the present disclosure are excellent for imaging processes, especially xerographic processes, which may operate with a toner transfer efficiency in excess of about 90 percent, such as those with a compact machine design without a cleaner or those that are designed to provide high quality colored images with excellent image resolution, acceptable signal-to-noise ratio, and image uniformity. Further, toners of the present disclosure can be selected for electrophotographic imaging and printing processes such as digital imaging systems and processes.

The imaging process includes the generation of an image in an electronic printing apparatus and thereafter developing the image with a toner composition of the present disclosure. The formation and development of images on the surface of photoconductive materials by electrostatic means is well known. The basic xerographic process involves placing a uniform electrostatic charge on a photoconductive insulating layer, exposing the layer to a light and shadow image to dissipate the charge on the areas of the layer exposed to the light, and developing the resulting latent electrostatic image by depositing on the image a finely-divided electroscopic material referred to in the art as “toner”. The toner will normally be attracted to the discharged areas of the layer, thereby forming a toner image corresponding to the latent electrostatic image. This powder image may then be transferred to a support surface such as paper. The transferred image may subsequently be permanently affixed to the support surface as by heat.

Developer compositions can be prepared by mixing the toners obtained with the embodiments of the present disclosure with known carrier particles, including coated carriers, such as steel, ferrites, and the like. See, for example, U.S. Pat. Nos. 4,937,166 and 4,935,326, the disclosures of each of which are hereby incorporated by reference in their entirety. The toner-to-carrier mass ratio of such developers may be from about 2 to about 20 percent, and in embodiments from about 2.5 to about 5 percent of the developer composition. The carrier particles can include a core with a polymer coating thereover, such as polymethylmethacrylate (PMMA), having dispersed therein a conductive component like conductive carbon black. Carrier coatings include silicone resins, fluoropolymers, mixtures of resins not in close proximity in the triboelectric series, thermosetting resins, and other known components.

Development may occur via discharge area development. In discharge area development, the photoreceptor is charged and then the areas to be developed are discharged. The development fields and toner charges are such that toner is repelled by the charged areas on the photoreceptor and attracted to the discharged areas. This development process is used in laser scanners.

Development may be accomplished by a magnetic brush development process as disclosed in U.S. Pat. No. 2,874,063, the disclosure of which is hereby incorporated by reference in its entirety. This method entails the carrying of a developer material containing toner of the present disclosure and magnetic carrier particles by a magnet. The magnetic field of the magnet causes alignment of the magnetic carriers in a brush like configuration, and this “magnetic brush” is brought into contact with the electrostatic image bearing surface of the photoreceptor. The toner particles are drawn from the brush to the electrostatic image by electrostatic attraction to the discharged areas of the photoreceptor, and development of the image results. In embodiments, the conductive magnetic brush process is used wherein the developer comprises conductive carrier particles and is capable of conducting an electric current between the biased magnet through the carrier particles to the photoreceptor.

The following Examples are being submitted to illustrate embodiments of the present disclosure. These Examples are intended to be illustrative only and are not intended to limit the scope of the present disclosure. Also, parts and percentages are by weight unless otherwise indicated.

### EXAMPLES

Any sources of beta carboxy ethyl acrylate (β-CEA) monomers can be used for the latex preparation. In this example, several different beta carboxy ethyl acrylate (β-CEA) monomers from Bimax® were selected. Latex emulsions were prepared as follows: In a 2 L jacketed glass flask with a stirrer (a four-blade steel impeller, 2.5 inches in diameter), a monomer emulsion was prepared by mixing a monomer mixture (about 410 grams of styrene, about 120 grams of n-butyl acrylate, about 16 grams of β-CEA, and about 3.2 grams of 1-dodecanethiol) with an aqueous solution (about 10.6 grams of Dowfax 2A1, about 256 grams of deionized water) at about 300 rpm for about 2 minutes on and off for 3 cycles at room temperature.

Viscosity was determined as follows: A Rheometrics Fluid Spectrometer from TA Instruments was used to determine viscosity in a Narrow Gap Couette viscometer where fluid was put between an inner solid cylinder and an outer rotating hollow cylinder. Knowing the radii of inner and outer cylinders, height of cylinders, angular velocities of inner and outer cylinders and torque on the inner cylinder, viscosity was calculated as.

$$η ( ) = \frac{τ ( {R}_{2} - {R}_{1} )}{2 \prod {R}_{1}^{3} H \vert {W}_{2} - {W}_{1} \vert} ,$$

where R₁, R₂=Radii of inner and outer cylinders, H=Height of cylinders, W₁, W₂=Angular velocities of inner and outer cylinders, and τ=Torque on inner cylinder. Shear rate, [symbol] at that viscosity was calculated as

$$= \frac{\vert {W}_{2} - {W}_{1} \vert {R}_{1}}{( {R}_{2} - {R}_{1} )} .$$

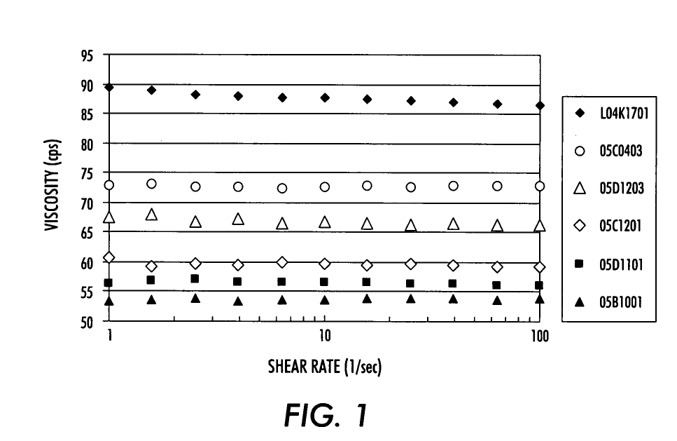

FIG. 1 shows the viscosity as a function of shear rate for the six different β-CEA lots.

All of the β-CEA lots had acrylic acid and oligmer compositions as shown in Table 1:

TABLE 1

| Acid | Ester | Acrylic | 2 Mole | 3 Mole | 4 Mole | 5 Mole | 6 Mole |
|---|---|---|---|---|---|---|---|
| Number | Value | Acid (wt %) | (wt %) | (wt %) | (wt %) | (wt %) | (wt %) |
| 6.1-6.7 | 6.4-7.0 | 19-22 | 34-36 | 24-26 | 11-13 | 4-5.5 | 1.5-2.0 |

The properties of these β-CEA lots from Bimax® were listed in Table 1, and FIG. 1. Newtonian behavior was observed for all the β-CEA lots, and the viscosity was in a range of about 50 to about 90 CPS. When the viscosity of the β-CEA was less than about 60 CPS (for example, with lot#05D1101 and 05B1001), the resulting latex emulsion was unstable. The resulting latexes had larger particle size (from about 250 nm to about 350 nm), broader particle size distribution (polydispersity D>about 1.3) with relatively higher latex sedimentation (>about 0.2 wt %), and broader molecular weight distribution (polydispersity D=Mw/Mn>about 4) than latex compositions when the viscosity of the β-CEA was from about 60 centipoise to about 90 centipoise. The latex compositions for stable emulsions had a molecular weight of from about 30 kpse to about 50 kpse, or from about 35 kpse to about 45 kpse, a polydispersity D of from about 1.05 to about 1.30, or from about 1.10 to about 1.20, and a particle size of from about 180 nm to about 250 nm, or from about 200 nm to about 240 nm.

It was found that the viscosity of the β-CEA monomer directly correlated with the amount of the acrylic acid in the β-CEA. The higher amount of acrylic acid, the lower the β-CEA viscosity, the less stable the resulting latex emulsion and the poorer quality of the resulting latexes.

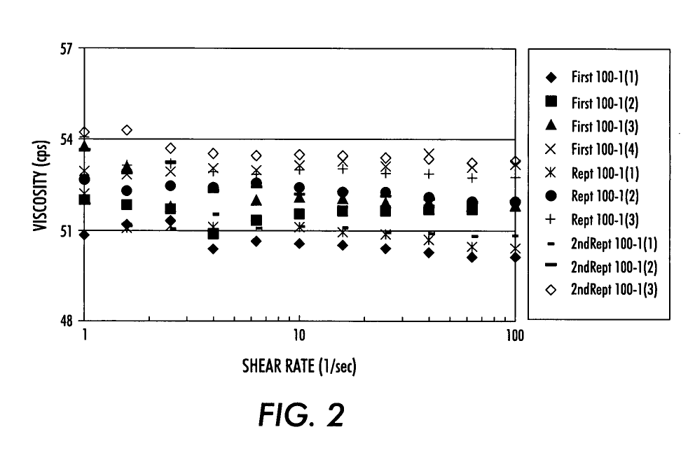

Repeat measurements of viscosity at shear rates between from about 1 sec⁻¹ to about 100 sec⁻¹ were taken for β-CEA monomer 05B1001. Shearing occurred in a Narrow Gap Couette Viscometer of Rheometrics Fluid Spectrometer produced by TA Instruments under conditions of initial rate at 1 Radian/Second and final rate of 100 Radians/Second with five (5) points taken per decade, data collection mode was time based with six (6) seconds delay before measurement and measurement time was five (5) seconds, direction of rotation was clockwise and direction per measurement was two. Viscosity was essentially Newtonian with little dependence on shear rate. Excellent repeatability was found in viscosity measurements along with the average and standard deviation (SD) as shown in Table 2 and FIG. 2. Viscosity measurements were in centipoise and taken at 10 sec⁻¹.

TABLE 2

| | Average | | | | | | | | | |
|---|---|---|---|---|---|---|---|---|---|---|
| | 50.58 | 51.61 | 52.24 | 53.11 | 51.03 | 52.30 | 53.05 | 51.13 | 52.47 | 53.60 |
| SD | 0.382 | 0.274 | 0.602 | 0.182 | 0.462 | 0.223 | 0.351 | 0.301 | 0.538 | 0.336 |

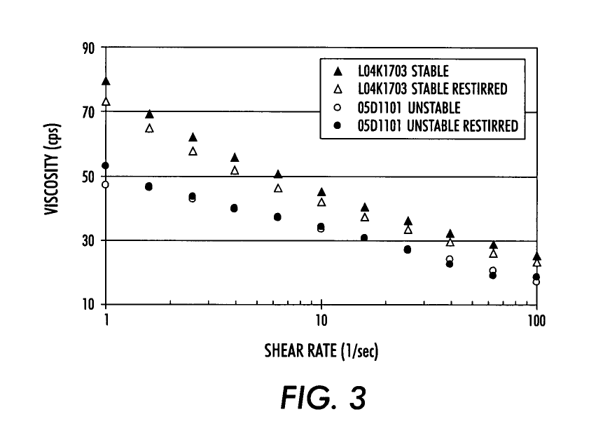

The viscosity of the latex emulsions prepared with the different β-CEA lots were compared as seen in FIG. 3. The stable latex emulsion prepared with β-CEA lot # L04K1703 (wherein the β-CEA monomer was obtained from Bimax® and had a viscosity of from about 88 CPS to about 90 CPS) had a higher viscosity than the unstable latex emulsion with β-CEA Lot# 05D1101. The latex emulsion prepared with the stable β-CEA lot showed higher emulsion viscosity and better emulsion stability (as determined by the phase separation at about 30 minutes) than the latex emulsion prepared with the unstable β-CEA Lot# 05D1101. Re-stirring of separated emulsions for 2 minutes under 300 rpm brought back the emulsions into one phase with about the same viscosity.

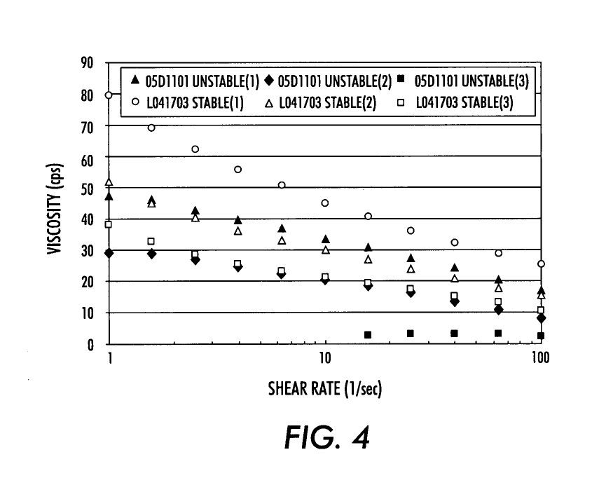

The emulsion stability was also quantified by the changes of the emulsion viscosity, which was measured at a certain time period. It was found that the latex emulsion prepared with unstable β-CEA lots had less of a decrease in the emulsion viscosity than emulsions prepared with stable β-CEA lots, as shown in FIG. 4. Further, the viscosity of a stable latex emulsion should be of from about 10 CPS to about 90CPS after shearing three consecutive times. As seen in FIG. 4, the viscosity of an unstable latex emulsion is less than about 10 CPS after shearing three consecutive times.

Visual inspection of emulsion stability as determined by phase separation after about three cycles of about 15 minutes (each cycle was for a time period of about 5 minutes) shearing at a shear rate of about 100 sec⁻¹ to about 1 sec⁻¹ and about five minutes of rest time could not characterize emulsion quality as seen in Table 3. The latex emulsions were prepared with three different β-CEA monomers in a same way as described above, using the same formulation. It was found that an unstable emulsions lead to an inhomogeneous latex with unpredictable toner properties and image quality such as gloss and offsetting.

TABLE 3

| | | | | Resulting latex Properties | | |
|---|---|---|---|---|---|---|
| | | | | par- | Molec- | Sedi- |
| | | | | ticle | ular | men- |
| β-CEA | | | | size | Weight | tation |
| Monomer | 1^{st} cycle | 2^{nd} cycle | 3^{rd} cycle | (nm) | (Kpse) | (wt %) |
| L04K1701 | Phase | No phase | No phase | 220 | 35.0 | 0.12 |
| stable | separation | separation | separation | | | |
| 05D1101 | Phase | No phase | No phase | 275 | 39.2 | 0.24 |
| unstable | separation | separation | separation | | | |
| 05C1301 | Phase | Phase | Phase | 315 | 45.1 | 0.38 |
| unstable | separation | separation | separation | | | |

Visual inspection could not differentiate between stable lot L04K1701 and unstable lot 05D1101. Viscosity of the emulsions, however, was a consistent and quantitative method to ensure high quality latex and toner. Hence, the quality of the toner particles eventually prepared can be controlled using both the viscosity measurements of the latex emulsion and the β-CEA monomer.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method comprising:
obtaining a latex emulsion;
shearing the latex emulsion at a rate of from about 100 sec⁻¹ to about 1 sec⁻¹; and
measuring the viscosity of the latex emulsion,
wherein the viscosity of the latex emulsion can be utilized to indicate stability of the latex emulsion.

2. The method according to claim 1, wherein the step of shearing the latex emulsion is repeated about three cycles.

3. The method according to claim 1, wherein the step of shearing the latex emulsion for one cycle is for a time of from about 3 minutes to about 10 minutes.

4. The method according to claim 1, wherein the step of shearing the latex emulsion for one cycle is for a time of from about 5 minutes to about 7 minutes.

5. The method according to claim 2, wherein the viscosity of the sheared latex indicating a stable latex is from about 10 centipoise to about 90 centipoise.

6. The method according to claim 5, wherein the viscosity of the sheared latex indicating a stable latex is from about 15 centipoise to about 80 centipoise.

7. The method according to claim 1, wherein the step of obtaining a latex emulsion includes obtaining a latex having a beta-carboxy ethyl acrylate monomer with a viscosity of from about 60 centipoise to about 90 centipoise.

8. The method according to claim 1, further comprising utilizing the viscosity of the latex emulsion to indicate the stability of a toner comprising the latex emulsion.

9. A method comprising:
obtaining a latex emulsion;
shearing the latex emulsion at a rate of from about 100 sec⁻¹ to about 1 sec⁻¹ for three consecutive cycles; and
measuring the viscosity of the latex emulsion during shear deformation,
wherein the viscosity of the latex emulsion can be utilized to indicates stability of a toner comprising the latex emulsion.

10. The method according to claim 9, wherein a viscosity of the latex emulsion from about 10 centipoise to about 90 centipoise will produce a stable toner.

11. A toner composition comprising a latex wherein the latex includes a beta-carboxy ethyl acrylate monomer having a viscosity of from about 60 centipoise to about 90 centipoise.

12. The toner composition according to claim 11, wherein the beta-carboxy ethyl acrylate monomer has a viscosity of from about 65 centipoise to about 80 centipoise.

13. The toner composition according to claim 11, wherein the latex further includes at least one submicron resin, an aqueous medium, and at least one surfactant.

14. The toner composition according to claim 13, wherein the latex is emulsified and sheared at a rate of from about 100 sec⁻¹ to about 1 sec⁻¹ for about three shear cycles.

15. The toner composition according to claim 14, wherein the sheared latex has a viscosity from about 10 centipoise to about 90 centipoises.

16. The toner composition according to claim 13, wherein the resin is selected from the group consisting of poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(styrene-1,3-diene-acrylonitrile-acrylic acid), poly(alkyl acrylate-acrylonitrile-acrylic acid) and poly(styrene butyl acrylate beta carboxyl ethyl acrylate).

17. The toner composition according to claim 11, wherein the toner further comprises a colorant, a wax, and optionally one or more components selected from the group consisting of surfactants, coagulants, surface additives, and optionally mixtures thereof.

18. The toner composition according to claim 11, wherein the toner comprises an emulsion aggregation toner.

19. The toner composition according to claim 11, wherein the toner has a particle size of from about 5.6 um to about 9.0 um and a polydispersity D of from about 1.05 to about 1.30.

20. The toner composition according to claim 11, wherein the toner has a molecular weight in a range of from about 30 kpse to about 50 kpse.
